(19) United States
(12) Patent Application Publication
(10) Pub. No.: US 2016/0375568 A1
(43) Pub. Date: Dec. 29, 2016

(54) Bearing Master Differential Bearing Puller

(71) Applicant: Michael James Punaro, Glen Allen, VA (US)

(72) Inventor: Michael James Punaro, Glen Allen, VA (US)

(21) Appl. No.: 15/193,044

(22) Filed: Jun. 25, 2016

Related U.S. Application Data
(60) Provisional application No. 62/184,625, filed on Jun. 25, 2015.

(51) Int. Cl. B25B 27/06

(52) U.S. Cl. CPC B25B 27/062

(57) ABSTRACT

Means of efficiently capturing the bearing with the collet comprising teeth elements and/or flanged collets.

### RELATED APPLICATIONS

The present application is a continuation application of U.S. provisional patent application Ser. No. 62/184,625, filed Jun. 25, 2015, for BEARING MASTER DIFFERENTIAL BEARING PULLER, by Michael Punaro, included by reference herein and for which benefit of the priority date is hereby claimed.

### FIELD OF THE INVENTION

The present invention relates to the efficient, fast, and safe bearing removal and, more particularly comprising collets with teeth elements for extra support during the removal process. This provide additonal support and removal force which in turn reduces the force needed to remove the bearings.

### BACKGROUND OF THE INVENTION

There are many bearing puller and installation tools in use throughout the manufacturing, maintenance, and repair industry. Most are cumbersome and inefficient in that they are not designed as precision tools.

Many times the removal process is somewhat awkward and introduces undue friction or misalignment between the bearing, puller, and component it is being removed from.

Damage to the bearing or component is often contributed to the design of the prior art of bearing pullers.

### SUMMARY OF THE INVENTION

In accordance with the present invention, there is provided means of efficiently capturing the and removing the bearing with the teeth elements in addition to a flange.

It would be advantageous to provide a simple and fast method to remove bearings.

It would also be advantageous to provide a safe method from removal of bearings.

It would further be advantageous to provide a easy methd to assemble and/or attache the bering puller to the bearing.

### BRIEF DESCRIPTION OF THE DRAWINGS

A complete understanding of the present invention may be obtained by reference to the accompanying drawings, when considered in conjunction with the subsequent, detailed description, in which:

FIG. 1 is an exploded view of a collet with the tooth elements, the removal sleeve, & the ram or pressure screw adapter.

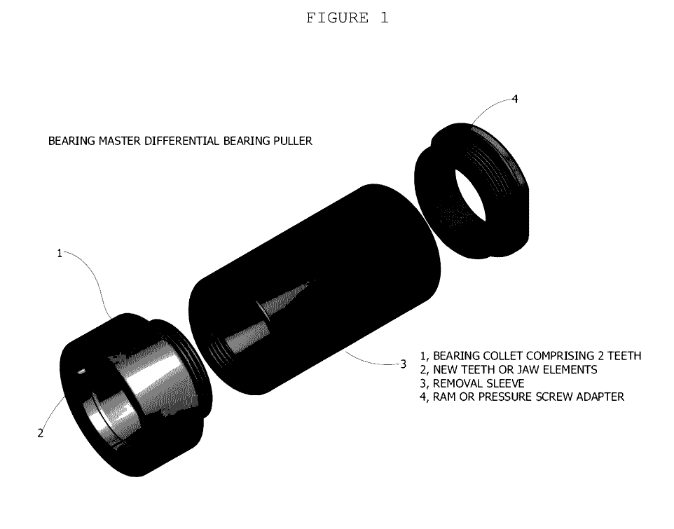

For purposes of clarity and brevity, like elements and components will bear the same designations and numbering throughout the Figures.

### DESCRIPTION OF THE PREFERRED EMBODIMENT

Bearing Master Differential Bearing Puller

There are many bearing puller and installation tools in use throughout the manufacturing, maintenance, and repair industry. Most are cumbersome and inefficient in that they are not designed as precision tools.

Due to this many times the removal process is somewhat awkward and introduces undue friction or misalignment between the bearing, puller, and component it is being removed from.

My Bearing Master bearing puller comprises precision machining to eliminate undue friction and/or misalignment. This new puller references my prior patent U.S. Pat. No. 7,980,604 with the additional benefit of a new and improved modified collets to include the new removal elements for the removal process. These elements may be integral to the collet or removable elements attached to the collet with bolts or screws or welded. This invention comprises a plurality of attachments such as item 1 collet with the added elements item 2 integral teeth to provide additional support and force during the removal process.

You will notice the removal sleeve 3 item 3 comprises apertures at both ends to allow for a plurality of collets and adapters to be fitted depending on the application. This makes this invention very versatile as not only do the adapters such as item 4 accept standard commercial hydraulic rams or manual pressure screws.

This new invention allows differential bearings and like bearings mounted onto journals or shafts without any of the lower inner race of the bearing visible. Most of these type mount have a indented area to allow a jaw type puller to clamp on the very small area of the bearing inner race. This jaw type puller is not accurate and is subject to slipping off of the bearing race during the removal process. My invention comprises precision collets with a plurality of added teeth, jaws, or other means to securely capture the inner race of the bearing without the possibility of slipping off due to the fact the collet is fastened to a removal sleeve 3 that hold the collet and attachments together. The plurality of collets also comprise internal flanges to assist with the removal force.

This new puller also benefits from being able to be used in confined or narrow spaces due to the fact the ram is slim and does not require and rotation as do normal pressure screw pullers. This greatly enhances the benefit of the complete puller set as one very compact, powerful, and precise tool.

This new invention also comprises a plurality of adapters and sleeves to fit common bearing sizes and the added benefit of being highly adaptable to fit any custom and/or special size of bearing or gear.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A bearing master differential bearing puller
bearing master differential bearing puller
bearing master differential bearing puller
bearing master differential bearing puller for easy, fast, & safe removal of bearings, comprising:
means for capture the bearing;
means for capture and support the bearing; and
means for <purpose>.

2. The bearing master differential bearing puller
bearing master differential bearing puller
bearing master differential bearing puller
bearing master differential bearing puller in accordance with claim 1, wherein said means for capture the bearing comprises a bearing collet.

3. The bearing master differential bearing puller
bearing master differential bearing puller
bearing master differential bearing puller
bearing master differential bearing puller in accordance with claim 1, wherein said means for capture and support the bearing comprises a tooth.

4. The bearing master differential bearing puller
bearing master differential bearing puller
bearing master differential bearing puller
bearing master differential bearing puller in accordance with claim 1, wherein said means for <purpose> comprises a removal sleeve.
